(19) United States
(12) Patent Application Publication
(10) Pub. No.: US 2021/0323821 A1
(43) Pub. Date: Oct. 21, 2021

(54) SEPARATION OF A STRONG ACID FROM ITS SALTS

(71) Applicants: Tali MALI, Jerusalem (IL); Recreo Pharmaceuticals LLC, Jerusalem (IL)

(72) Inventors: Asher VITNER, Jerusalem (IL); Tali MALI, Jerusalem (IL)

(21) Appl. No.: 17/272,870

(22) PCT Filed: Aug. 6, 2019
(86) PCT No.: PCT/IL2019/050893

§ 371 Date: Mar. 2, 2021

Related U.S. Application Data
(60) Provisional application No. 62/719,141, filed on Aug. 17, 2018.

(51) Int. Cl. C01B 7/03

(52) U.S. Cl. CPC C01B 7/035

(57) ABSTRACT

The present invention relates to a process for the separation of strong acid from its salts. In said process, a strong acid salt is reacted with organic weak base (OWB) in the presence of a hydrophilic solvent and CO₂. The cation of the strong acid salt is precipitated to produce a carbonate/bicarbonate salt and the strong acid form a liquid salt with the OWB. The above process is performed in a solution comprising both the strong acid salt and the WBO. In the next step, the strong acid is released from its OWB liquid salt and the OWB is returned to a previous step.

### FIELD OF THE INVENTION

The present invention relates to a novel process for the separation of a strong acid from its salts. The process yields a carbonate salt and the acid.

### BACKGROUND OF THE INVENTION

Strong acid salts are produced as by-products in numerous industrial processes. In many cases, the produced salts exit the production plants as waste. The waste needs to be disposed of and such removal results in the contamination of the environment. The present invention provides a cheap process in which the strong acid can be produced from its salt and recycled.

Mining Industry—Ores are used for the extraction of metal cationic products. The leaching products contain also a variety of foreign cations. Strong acids are used in the leaching process and salts of those cations are produced as waste. The present invention gives a way to reduce the amount of the waste while recycling the acid to the ore leaching step.

In other processes in the chemical and biotechnological industry acids and/or bases are added and waste salts are produced. The present invention gives a way to reduce the amount of this waste and reuse the acid and or base.

The increase in CO₂ level in the atmosphere has a significant contribution to the global heating problem. The present invention gives a method for the fixation of CO2 as a carbonate salt thus reducing both air pollution and environmental pollution.

Using the present invention, the MCl₂ waste solution can be converted to MCO₃ and HCl

OWB+MCl₂+CO₂═OWB*HCl+MCO₃ Eq. 1

OWB*HCl═OWB+HCl Eq. 2

OWB=Organic weak base. Wherein a weak base, in this patent is a base having a pK1/2 lower than 1.5. pK1/2 is the pH in an aqueous phase that is in contact with a phase comprising OWB*HCl and OWB at OWB*HCl/(OWB+OWB*HCl) of 0.5

The process suggested here can be used for the assimilation of CO₂ in carbonate salts splitting of strong acid salts into the acid and a conjugated base (wherein bicarbonate and carbonate are considered here also as base) is an urgent need in many industries. Developing methods for this operation will lead to the reduction of the amount of waste produced in those industries.

Processes have been suggested to separate weak acids from their salts to obtain the free weak acid:

Baniel's U.S. Pat. No. 5,510,526, demonstrated splitting sodium lactate and forming sodium bicarbonate as the conjugated base. Baniel found a way to efficiently combine tri-alkyl amine with several driving forces in his process; thermal energy, the (chemical) crystallization energy of NaHCO, the (chemical energy) of high reagent concentration, the (mechanical) energy of C02 pressurization and the thermal sensitivity of carboxylic acid extraction (U.S. Pat. No. 4,275,234).

Several patents demonstrated the extraction of free HCl from diluted solutions and for the later recovery of concentrated HCl by stripping of the amine:

(Baniel and Jansen, US patent application No. 2012/0134912; Baniel and Eyal, US patent application No. 2010/0093995, US patent application No. 2011/0028710 and EP 2 321 218 A1; Baniel, Eyal and Jansen, WO 2010/064229 A2; Coenen, Kosswig, Hentschel and Ziebarth, U.S. Pat. No. 4,230,681; Willi Ziegenbein, Ferdinand von Praun, U.S. Pat. No. 4,272,502 A; DeVries, U.S. Pat. No. 4,640,831 A), demonstrate that HCl can be extracted from its acid solution using the Weak base extractant TEHA (Tri rthyl hexyl amine). The extracted HCl is released from TEHA by heating the loaded extractant at 140 C-170° C. to give HCl gas of low vapor pressure or by back extraction to give HCl solution.

Asuncion Aranda (CA2973558A1) has demonstrated that in the presence of CO₂, CaCl₂ can be split by TOA (Tri octyl amine) to give CaCO₃ and TOA*HCl. In this case, Back-Extraction of the extracted acid is expected to give a very dilute HCl solution. In order to overcome the difficulty, it was suggested to wash the extracted HCl with a base. It was also suggested to use weaker amine extractants such as TEHA to extract HCl from CaCl₂ but such extraction was not tried in that patent and trial done for the present patent gave negative results.

With the current art in our mind it was concluded that that no process' was suggested up to date for both the extraction of a strong acid from its salt, in the presence of CO₂ and releasing the acid to give high enough concentration, and a process novel approach should be developed in order to enable both efficient extraction of a strong acid from its salts and the release of the strong acid at high enough concentration.

Strong acids can be extracted from their salts, at high CO₂ level, by Medium base amine such as TOA but cannot be released efficiently as free acid to give a acid solution at reasonable concentration. On the other hand, Weak base amine such as TEHA cannot extract strong acids from their salts even at high CO₂ pressure. Those observations lead us to the conclusions that such a process might be feasible only if there will be a method to perform the salt split using an “extractant’ comprising OWB, of sufficient high basicity to perform a reaction presented in Eq. 1 following by step to drastically reduce the basicity of a weak organic base and release of the strong acid from the amine.

OWB+MX+water+CO₂═OWB*HX+M-carbonate or M-bicarbonate Eq. 3

### Wherein:

OWB is an organic weak base;
HX is a strong acid having at least one proton with pK1/2 lower than 2; and
MX is a salt of strong acid.

In the next step, the basicity of the OWB is reduced and the strong acid HX is release from the OWB using any conventional method such as Back-Extraction or distillation of the HX from the OWB*HX at elevated temperature

OWB*HX═OWB+HX Eq. 4

It was found that in the case of a hydrophobic OWB, addition of a hydrophilic solvent to the reaction mixture might induce the dissolution of both the strong acid salt and the amine (along with water), in the same phase at reasonable concentration. In this case, the basicity of the OWB, in the resulting phase increases and the reaction described in Eq 3 takes place.

In the cases in which the reaction phase does not include both the OWB and the MX and a significant second, aqueous phase is present, the loading of HX upon the OWB becomes low and practically no M carbonate/bicarbonate is precipitated and practically no OWB+HX is formed.

In the next step HX should be released from OBE*HX. In order to enable this step, one or more of the following operations or the combination of the following operations must be performed:
1—Removing the hydrophilic solvent (for example by distillation);
2—Addition of an hydrophobic solvent;
3—Removing of water (for example, by distillation);
4—Increasing the temperature of the OWB*HX and release of the HX as HX vapor;
5—Addition of water and inducing Back extraction;
6—Other methods inducing separation of the acid from the amine.

The aim of operation 1-3 is to shift the PK1/2 of the OWB from that of Stronger Base (as in Step 1) to a much weak base and the aim of the other operations is to decrease the bond strength between OWB and the acid.

### SUMMARY OF THE INVENTION

In accordance with the invention it has surprisingly been found that strong acid can be separated from its salts in an organic phase comprising a hydrophilic solvent. OWB and the strong acid salt, in the presence of CO₂. A carbonate/bicarbonate salt is produced and the acid stays in solution. The removal of the solvent from the organic phase enables the release of the free acid from the resulting solvent-free organic phase to give the free acid at reasonable concentrations (at above 0.1 M).

In some embodiments, this invention therefore provides a process for the recovery of a strong acid from it salt comprising the steps of:
1. preparing a solution comprising (a) at least one organic weak base (OWB), (b) at least one hydrophilic solvent and (c) a salt of a strong acid;
2. adding CO₂ into the solution inducing the precipitation of carbonate salt or bicarbonate salt or a combination thereof;
3. removing at least part of the resulting suspension and separating the precipitated salt to obtain a clear solution;
4. separating the hydrophilic solvent from the clear solution; and separating the strong acid from the OWB and recycling the OWB to step 1

In some embodiments, the solution in step 1 comprises more than one solvent and in some embodiments, the second solvent is more hydrophobic as compared to 1-propanol.

In some embodiments, the all or substantially all of the strong acid salt is present in said solution and in some embodiments, all or substantially all of the OWB*HX is present in said solution.

It is to be understood that reference to “substantially all” with respect to the strong acid salt present in the solution in step 1 of the method as described herein, refers to the fact that the distribution coefficient of the acid between the solution and any other liquid phase is higher than 10. Similarly, it is to be understood that reference to “substantially all” with respect to the OWB*HX present in the solution in step 1 of the method as described herein, refers to the fact that less then more than 95 wt % of the amount of OWB*HX is present in the said solution.

In some embodiments, the strong acid has a pK1/2 lower than 1.5. In some embodiments, the strong acid is an halogenic acid, nitric acid, sulfuric acid, phosphoric acid or the combination thereof.

In some embodiments, the cation of salt of strong acid is selected from monovalent cations or divalent cations and in some embodiments, the cation of salt of strong acid is ammonium or sodium or magnesium or calcium or a combination thereof.

In some embodiments, the strong acid salt is one of CaCl₂, NaCl or MgCl.

In some embodiments, the hydrophilic solvent is a solvent wherein the solubility of water in it is higher than 10% and in some embodiments, the hydrophilic solvent is selected from the group of C₁-C₄ alkanol, C₁-C₄ ester, polyols, polyol ethers, polyol esters, hydrophilic polar solvents and a combination thereof. In some embodiments, the hydrophilic solvent is selected from 1-propanol, iso butanol or third butanol or the combination thereof.

In some embodiments, the CO₂ pressure is lower than 10 atm, and in some embodiments, the CO₂ pressure is higher than 5 atm. In some embodiments, the pK1/2 of the OWB is lower than 2.5 and in some embodiments, the pK1/2 of the OWB is lower than 1.5 and in some embodiments, the pK1/2 of the OWB is between 0 and 1.

In some embodiments, the OWB is an amine or comprises P or comprises S or a combination thereof and in some embodiments, the OWB is a branched tertiary amine, wherein in some embodiments, one or more of the chains of the organic tertiary amine is comprises 1 to 8 carbons and in some embodiments, one or more of the chains of the comprises a more complex side chain wherein the side chain is selected from isoprene, cyclic or aromatic compound or other compound of complex nature.

In some embodiments, the OWB is tri ethyl hexyl amine and in some embodiments, OWB has lower molecular weight as compared to tri ethyl hexyl amine.

In some embodiments, the solution comprises a diluent.

In some embodiments, the acid is removed from the phase comprising OWB by back extraction with water and in some embodiments; the back extraction is performed at temperature higher than 40° C.

In some embodiments the acid is removed from the phase comprising OWB by evaporation to a temperature higher than 100° C. and in some embodiments, the acid is removed from the phase comprising OWB by evaporation to a temperature higher than 130° C. In some embodiments, the acid is removed from the phase comprising OWB by contact with a base or a carbonate salt or a bicarbonate salt.

In some embodiments, the strong acid salt is a waste from the chemical industry and in some embodiments the strong acid salt is a waste from a process for the production of one of sodium carbonate or sodium bicarbonate or a combination thereof. In some embodiments, the strong acid salt is a waste from the agriculture industry or the biotechnology industry. In some embodiments, the CaCl₂ is a waste from a process for the production of Na₂CO₃, NaHCO₃ or a combination thereof.

In some embodiments, the reaction is carried out continuously.

### DETAILED DESCRIPTION OF THE INVENTION

This invention provides processes whereby a strong acid can be recovered from it salt in an industrially applicable and environmentally friendly setting.

As described herein, it has surprisingly been found that strong acid can be separated from its salts in an organic phase comprising a hydrophilic solvent, OWB and the strong acid salt, in the presence of CO₂. A carbonate/dicarbonate salt is produced in this process and the acid stays in solution. The removal of the solvent from the organic phase enables the release of the free acid from the resulting solvent-free organic phase to give the free acid at reasonable concentrations (at above 0.1 M).

In some embodiments, this invention therefore provides a process for the recovery of a strong acid from it salt comprising the steps of:
1. preparing a solution comprising (a) at least one organic weak base (OWB), (b) at least one hydrophilic solvent and (c) a salt of a strong acid;
2. adding CO₂ into the solution inducing the precipitation of carbonate salt or bicarbonate salt or a combination thereof;
3. removing at least part of the resulting suspension and separating the precipitated salt to obtain a clear solution;
4. separating the hydrophilic solvent from the clear solution; and separating the strong acid from the OWB and recycling the OWB to step 1

It was found that if there is more than one liquid phase, the efficiency of the process decreases. This effect increases with the increase in the volume of a water rich phase.

The skilled artisan will appreciate that three types of liquid phases may arise, (1) a phase comprising mainly of OWB with practically no salt or water, (2) a phase comprising mainly salt and water but no or low amount of OWB and (3) a liquid phase comprising the solvent, the OWB, OWB*HX, water and the salt. If there was only one liquid phase, comprising the solvent, OWB, OWB*HX, water and the salt and no additional liquid phase, the salt split into a carbonate salt and OWB*HX salt is efficient. In many cases in which the other types of phases were also present in addition to the solvent-OWB-salt phase, there was no precipitation of the carbonate salt.

Thus, according to the present invention there is now provided a process for the production of strong acid from its salt, comprising the steps of:
(a) Forming a liquid phase comprising of a strong acid salt, OWB and a hydrophilic solvent;
(b) Addition of CO₂ and inducing the precipitation of a carbonate salt;
(c) Removing of at least part of the carbonate salt and said liquid phase;
(d) Removing the hydrophilic solvent from said liquid phase;
(e) Releasing the strong acid from the resulting solution and;
(f) Recycling the resulting solution and the solvent to step (a).

Based on those findings, the invention provides in a process of recovering a strong acids from its salts using OWB and the solvent and efficiently releasing that strong acid. In a preferred embodiment the hydrophilic solvent is a low molecular, at least partially water-miscible organic compound being a member selected from the group of C₁-C₅ alkanols, acetates of C₁-C₃ alkanols. In another preferred embodiment the hydrophilic solvent is a polyol, or polyol ethers or ethers. In another preferred embodiment of the solvent has boiling point higher then 150° C. and is more hydrophilic then butanol.

The method of the invention is preferably carried out continuously. In this case the solution comprises also the strong acid (as OWB*HX) which has solubility higher than OWB itself in the solution, thus reducing the amount of solvent required to form a single liquid phase.

In another preferred embodiment, the preferred solvent is selected from polar solvents with high solubility in water. In a preferred embodiment, the hydrophilic solvent is DMSO, DMSO, methyl formamide or other hydrophilic polar solvents

The present invention also provides a method for separation of HCl from CaCl₂ waste stream obtained in the mining industry while producing CaCO₃ and HCl that can be recycled to the ore-leaching step of that process or sold as HCl solution. In a similar way, the present invention can be used for separation of strong acids other than HCl from mining industry thus recycling the strong acid to previous steps and producing carbonate, or bicarbonate salts or oxides.

The present invention also provides a method for converting CO₂ present in aqueous solution, gas or other sources, to carbonate salts thus producing carbonates of monovalent or divalent cations. Such a process is very much needed in order to tackle global warming by bonding CO₂ as carbonate salts and reducing the accumulation rate of CO₂ in the atmosphere.

In a preferred embodiment, the cation in the strong acid salt is a divalent cation or a monovalent cation.

In a more preferred embodiment the cation is a divalent cation and in a more preferred embodiment the cation is one of Ca or Mg or the combination thereof. In another preferred embodiment the cation is a monovalent cation and in more preferred embodiment the cation is ammonium or sodium.

In a preferred embodiment the strong acid is selected from HCl, halogenic acids, H₂SO₄, HNO₃, H₃PO₄.

In a more preferred embodiment the salt is CaCl₂ or MgCl₂.

In a preferred embodiment, OWB is organic weak base having pK1/20.5 lower than 2.5. In a more preferred embodiment the pK1/20.5 of the OWB is lower than 1.5. In a more preferred embodiment the pK1/20.5 of the OWB is lower than 1. In a preferred embodiment OWB is a branch tertiary amine. In a more preferred embodiment the OWB is tri ethyl hexyl amine (TEHA). In a preferred embodiment the OWB is a branch tertiary amine having a pK1/20.5 lower than 1.5 and higher than 0.

pK1/2_{0.5} of OWB is the pH measured at an aqueous phase that is in contact with the organic phase comprising the OWB at HCl to OWB molar ratio of 0.5

In another preferred embodiment, the OWB comprises a element selected from C, P, O, N, S and the combination of.

In a preferred embodiment, the solvent and water are removed in step (d) by cooling the solution to get a phase comprising most of the amine and the strong acid and a second liquid phase comprising most of the water, solvent, water, and most of the strong acid salt. In that embodiment at least part of that phase is recycled to (a).

In a preferred embodiment, the solvent and water are removed in step (d) by evaporation or distillation. And in another preferred embodiment, the solvent is removed in step (d) by extraction of at least part of the hydrophilic solvent into a less hydrophilic solvent. In this preferred embodiment, the resulting solvent-depleted solution is split into a phase comprising most of the solvent and water and another phase comprising most of the amine and strong acid.

In a preferred embodiment the strong acid is separated from the amine by evaporation at temperature higher that 100° C., in a more preferred at a temperature higher than 120° C.

In another preferred embodiment the strong acid is separated from the amine by back-extraction into an aqueous solution. In a preferred embodiment, the back-extraction is performed at a temperature higher than 50° C. In another embodiment, the back extraction is performed at a temperature higher than 70° C.

### EXAMPLES

### Example 1: Separation of HCl from its Salt in a Solution Comprising MgCl₂

Procedure

A solution comprising 72.2 wt % 1-propanol, 21.8% TEHA (Tri ethyl hexyl amine) and 6 wt % of 50 wt % MgCl₂ aqueous solution was stirred at RT in a closed vessel. CO₂ at a pressure of 2 bar. was introduced into the solution. After 1 hour, the crystals were filtered and the solution was titrated for acid content. (TEHA is an OWB)

Results

The molar ratio between the acid and the amine is 0.85.

### Example 2: Separation of HCl from NaCl Solution Using TOA as the OWB

Procedure

A solution comprising 62 wt % Iso-propanol, 15.1% TOA (Tri octyl amine) (TOA is an organic base that is much stronger then TEHA) and 62.9 wt % of 13 wt % NaCl aqueous solution was stirred at RT in open vessel. CO₂ was bubbled into the solution. After 1 hour, the crystals were filtered and the solution was titrated for acid content.

Results

The molar ratio between the acid and the amine is 0.85.

Conclusion

In the case of TOA which is a much stronger base than TEHA, HCl can be separated from NaCl solution

### Example 3: Separation of HCl from its Salt in a Solution Comprising CaCl2

Procedure

A solution comprising 72.2 wt % 1-propanol, 21.8% TEHA (Tri ethyl hexyl amine) and 6 wt % of 50 wt % MgCl2 aqueous solution was stirred at RT in a closed vessel. CO₂ at a pressure of 2 bar was introduced into the solution. After 1 hour, the crystals were filtered and the solution was titrated for acid content.

Results

| [CaCl₂] | % | | % | % | | Z |
|---|---|---|---|---|---|---|
| Wt | CaCl₂ | | solvent | TEHA | CO₂ | Mole |
| % in | In final | | in final | in final | Pressure | HCl/mole |
| water | solution | Solvent | solution | solution | bar | Amine |
| 40 | 6.1 | Iso | 80.4 | 13.5 | Bubbling | 0.55 |
| | | PrOH | | | for 2 hours | |
| 40 | 6.1 | Iso | 81.5 | 12.4 | Bubbling | 0.58 |
| | | PrOH | | | for 2 hours | |
| 37 | 7.1 | Iso | 79.7 | 13.2 | 2 | 0.7 |
| | | PrOH | | | | |
| 37 | 10.3 | Ethanol | 68.9 | 20.8 | 2 | 0.46 |
| 37 | 3.5 | butanol | 75.4 | 21.1 | 2 | 0.25 |
| 37 | 3.2 | Tert | 73.4 | 23.4 | 2 | 0.22 |
| | | butanol | | | | |
| 37 | 1.4 | Tert | 82.6 | 16 | 2 | 0.26 |
| | | butanol | | | | |
| 37 | 2.8 | 1 | 75.5 | 21.7 | 2 | 0.56 |
| | | propanol | | | | |
| 50 | 6.4 | 1 | 57.2 | 36.4 | 2 | 0.27 |
| | | propanol | | | | |
| 24 | Separate | No | 0 | 100 | 7 | (2 liquid |
| | aquaous | solvent | | | | phases) |
| | phase | | | | | |
| 24 | Separate | octanol | 50 | 50 | 7 | (2 liquid |
| | aquaous | | | | | phases) |
| | phase | | | | | |
| 24 | Separate | octanol | 78 | 72 | 7 | (2 liquid |
| | aquaous. | | | | | phases) |
| | phase | | | | | |

Z = the molar ratio between HCl to the amine

Conclusion

In a case in which there is a solution comprising the TEHA (the OWB), solvent and the salt with no or with insignificant presence of a second phase, HCl was released from the salt and CaCO₃ was produced. The reaction was efficient even when CO₂ was bubbled to the solution in an open vessel.

In the case of octanol as the solvent, 2 liquid phases are formed and there is practically no CaCl2 in the solvent phase. In this case even at 7 bar of CO₂ and high solvent content, HCl was not separated from its salt and no CaCO₂ was formed.

### Example 4: Increasing the Solubility of the Amine by Starting at High Z

| | | | | | | | | Final |
|---|---|---|---|---|---|---|---|---|
| | | | | | | | | Z |
| | [CaCl₂] | | % | | % | % | CO₂ | Mole |
| | Wt % | | CaCl2 | | solvent | TEHA | Pres- | HCl/ |
| | in | Initial | In final | Sol- | in final | in final | sure | mole |
| No | water | Z | solution | vent | solution | solution | bar | Amine |
| 4.1 | 50 | 60.9 | 8.1 | 1 | 80.4 | 31 | 2 | 0.75 |
| | | | | PrOH | | | | |
| 4.2 | 40 | 69 | 10.8 | 1 | 81.5 | 12.4 | 35 | 0.86 |
| | | | | PrOH | | | | |

*Crystals were formed in both experiments

Conclusions

In a continuous production, the solution is expected to contain also HCl, Addition of HCl to the solution during the reaction led to a significant increase in Z.

### Example 5 the Effect of Presence of a Second Liquid Phase

In most cases in this experiment the solvent is 1-PrOH. (Some of the experiments that are presented in this table are also presented in Experiments 1 and/or 2).

| [CaCl2] | % | | % | % | | | |
|---|---|---|---|---|---|---|---|
| Wt % | CaCl2 | | solvent | TEHA | CO₂ | Z Mole | No of |
| in | In final | | in final | in final | Pressure | HCl/mole | liquid |
| water | solution | Solvent | solution | solution | bar | Amine | phases |
| 40 | 10.8 | 1-PrOH | 81.5 | 12.4 | 35 | 0.86 | 1 |
| 50 | 8.1 | 1-PrOH | 80.4 | 31 | 2 | 0.75 | 1 |
| 37 | 2.8 | 1-PrOH | 75.5 | 21.7 | 2 | 0.56 | 2, |
| | | | | | | | (a small |
| | | | | | | | TEHA |
| | | | | | | | phase) |
| 37 | 3.5 | 1-BuOH | 75.4 | 21.1 | 2 | 0.25 | 2, bigger |
| | | | | | | | lower |
| | | | | | | | phase |
| 37 | 3.3 | 1-PrOH | 73.5 | 23.5 | 2 | 0 | 2 large |
| | | | | | | | TEHA |
| | | | | | | | phase) |
| 37 | | MeOH | 73.3 | 23.7 | 2 | 0 | 2 large |
| | | | | | | | TEHA |
| | | | | | | | phase) |
| 50 | 9.1 | 1-PrOH | 60.9 | 31 | 2 | 0 | 3 liquid |
| | | | | | | | phases |

Solvents: MeOH = methanol, PrOH = propanol, BuOH = butanol

Conclusions

In all cases in which more than 1 liquid phase, Z was decreased significantly. If the second phase was significant in size, the reaction did not yield CaCO₃ crystal and HCl was not produced. In the case in which 3 significant liquid phases were present, no reaction was observed

### Experiment 6. Separation of HCl from CaCl2 and Release of HCl from the OWB

### Using TOA as the OWB,

Experiment 6.1. No solvent

Procedure

5 gr, 27% CaCl2 solution and 5 gr TOA (Tri octyl amine) were into a vessel. No solvent was added and 2 liquid phases were present. The solution was stirred at RT in a closed vessel. CO₂ at a pressure of 7 bar. was introduced into the solution. After 1 hour, the crystals were filtered and the solution was titrated for acid content.

Result: Z=0.36

Comparative Experiment 6.2. TOA as the OWB ethanol as the solvent, P—CO₂=2 bar.

Procedure: The procedure is similar to that in Experiment 6.1. but with ethanol as the solvent. A single liquid phase was present and CaCO₃ crystals were formed.

Results: Z=1

Step 2: Back Extraction

9 gr of the upper phase was introduced into a vial. The solution was stripped at 60 C, to remove all of the ethanol.

10 gr water is added into the vial and the solutions are stirred at RT for 30 min. a sample from the aqueous phase was analyzed for acidity.

Result: The concentration of HCl in the aqueous phase is 0.18 wt %.

Conclusions:

The acid could not be back extracted to give reasonable concentration.

Experiment 6.2 TEHA as OWB, 1-propanol as the solvent.

Step 2 Back-Extraction

9 gr of the upper phase obtained in the solution of Experiment 4.1 was introduced into a vial. The solution was stripped at 60 C, to remove all of the solvent.

10 gr water is added into the vial and the solutions are stirred at RT for 30 min. a sample from the aqueous phase was analyzed for acidity.

Result: The concentration of HCl in the aqueous phase is 6 wt %.

Conclusions: The HCl that was separated from CaCl2, using TEHA in a single phase, could be back-washed to give an aqueous solution of 6 wt %.

It will be evident to those skilled in the art that the invention is not limited to the details of the foregoing illustrative examples and that the present invention may be embodied in other specific forms without departing from the essential attributes thereof, and it is therefore desired shat the present embodiments and examples be considered in all respects as illustrative and not restrictive, reference being made to the appended claims, rather than to the foregoing description, and all changes which come within the meaning and range of equivalency of the claims are therefore intended to be embraced therein.

1-35. (canceled)

36. A process for recovering a strong acid from its salt, said process comprising:
(i) preparing a solution comprising (a) at least one organic weak base (OWB), wherein said at least one OWB is a tertiary amine, (b) at least one hydrophilic solvent wherein said at least one hydrophilic solvent is a C₁-C₄ alkanol, a polyol, polyol ether, or a polyol ester, and (c) a salt of a strong acid;
(ii) adding CO₂ to the solution to produce a precipitated salt, wherein said precipitated salt comprises a carbonate salt, a bicarbonate salt, or a combination thereof;
(iii) separating the precipitated salt to obtain a clear solution;
(iv) separating the hydrophilic solvent from the clear solution;
(v) separating the strong acid from the OWB; and
(vi) optionally recycling said separated OWB to step (i).

37. The process of claim 36, wherein a pK_{1/2} of the strong acid is lower than 1.5, wherein said pK_{1/2} is the pH in an aqueous phase that is in contact with a phase comprising OWB*HCl and OWB at OWB*HCl/(OWB+OWB*HCl) of 0.5.

38. The process of claim 36, wherein said salt of strong acid comprises a monovalent cation, a divalent cation, or a combination thereof.

39. The process of claim 38, wherein said cation is ammonium, sodium, magnesium, calcium, or a combination thereof.

40. The process of claim 36, wherein the strong acid is a halogenic acid, nitric acid, sulfuric acid, phosphoric acid, or the combination thereof.

41. The process of claim 36, wherein a solubility of water in said hydrophilic solvent is higher than 10%.

42. The process of claim 36, wherein the hydrophilic solvent is selected from the group consisting of 1-propanol, iso-butanol, a third butanol, and a combination thereof.

43. The process of claim 36, wherein the solution comprises a second solvent.

44. The process of claim 43, wherein the second solvent is more hydrophobic than 1-propanol.

45. The process of claim 36, wherein the CO₂ pressure is lower than 10 atm and wherein the CO2 pressure is higher than 5 atm.

46. The process of claim 36, wherein the pK_{1/2} of the OWB is lower than 2.5, wherein said pK_{1/2} is the pH in an aqueous phase that is in contact with a phase comprising OWB*HCl and OWB at OWB*HCl/(OWB+OWB*HCl) of 0.5.

47. The process of claim 46, wherein the pK_{1/2} of the OWB is between 0 and 1.

48. The process of claim 36, wherein said OWB comprises an amine, a phosphorous, a sulfur, or a combination thereof.

49. The process of claim 36, wherein said OWB is a branched tertiary amine.

50. The process of claim 49, wherein said OWB is triethyl hexylamine, or has lower molecular weight than triethyl hexylamine.

51. The process of claim 49, wherein one or more of the chains of the branched tertiary amine comprises 1 to 8 carbons.

52. The process of claim 49, wherein the solution further comprises a diluent.

53. The process of claim 36, wherein said step of separating the strong acid from the OWB comprises extraction with water at temperature higher than 40° C.

54. The process of claim 36, wherein said step of separating the strong acid from the OWB comprises an evaporation process a temperature higher than 130° C.

55. The process of claim 36, wherein said step of separating the strong acid from the OWB comprises contacting said solution obtained in step (iv) with a base, a carbonate salt, or a bicarbonate salt.
